(19) United States
(12) Patent Application Publication
(10) Pub. No.: US 2011/0141888 A1
(43) Pub. Date: Jun. 16, 2011

(54) DATA TRANSPORT METHOD FOR PROTECTING PRIORITY DATA STREAMS IN A NETWORK

(75) Inventors: Jérémie Leguay, Paris (FR); Vania Conan, Paris (FR)

(73) Assignee: Thales, Neuilly Sur Seine (FR)

(21) Appl. No.: 12/746,598

(22) PCT Filed: Dec. 5, 2008
(86) PCT No.: PCT/EP2008/066932

§ 371 Date: Feb. 28, 2011

(30) Foreign Application Priority Data
Dec. 7, 2007 (FR) 0708547

(51) Int. Cl. H04W 24/00; H04L 12/26

(52) U.S. Cl. 370/230; 370/252

(57) ABSTRACT

Device and method for transporting data streams in a network including several nodes in a given configuration at a given instant. The device includes a database storing the message(s) to be transmitted; a congestion control module connected to the database; a scheduler having as inputs the messages stored in the database, the route determined for a message by a routing table and a neighboring node table and information coming from a receiving module; a module comprising an opportunistic transport protocol receiving information from the scheduler and from a measurement module, the opportunistic transport protocol being designed to split a message to be transmitted into N packets Pᵢ, and transmitting said packets to the network layer of the node; and a module designed to decide if the current node is capable of accepting an incoming handover of a message.

### CROSS REFERENCE TO RELATED APPLICATIONS

This application is the U.S. National Phase application under 35 U.S.C. §371 of International Application No. PCT/EP2008/066932, filed Dec. 5, 2008, and claims the benefit of French Patent Application No. 0708547, filed Dec. 7, 2007, all of which are incorporated by reference herein. The International Application was published on Jun. 11, 2009 as WO 2009/071688.

### FIELD OF THE INVENTION

The invention relates to a method and a system for transporting data having no delay constraints and also data that can be considered as priority data in an ad-hoc wireless network. It is used to protect the real-time or high-priority streams relative to other data streams.

The transport procedure according to the invention may be adopted in the case of ad-hoc networks or domestic infrastructures so as to protect the VoIP telephony and IPTV (IP television) services that are becoming increasingly widespread. The procedure may be implemented in mobile ad-hoc wireless networks, better known as wireless mesh networks.

### BACKGROUND

Ad-hoc networks may be composed of communicating wireless entities such as portable computers, cellular telephones, or sensors. These various entities constitute the nodes of an ad-hoc network, in which the network observes the input and output of these entities. In these networks, communication is in general possible only between the nodes in wireless range. A routing protocol (for example the OLSR (Optimized Link State Routing) protocol or the AODV (Ad-hoc On Demand Vector) protocol then ensures the relaying of the IP packets in order to provide connectivity from end to end. The nodes in the network may or may not be mobile.

It is often difficult to obtain good performance in this type of network because of the great variability and unpredictability of the wireless conditions and because all the nodes share the same communication medium. In a context in which the ad-hoc network must support as a priority real-time traffic, such as voice over IP, which may correspond to an emergency intervention situation or to a tactical network, data transport using the usual protocols, for example the TCP protocol, proves to be ineffective, as it is deleterious to real-time or priority data streams by adding delay and causing packet losses. This is because real-time services generate traffic that is generally not very tolerant to data loss or packet loss and are greatly affected by high levels of IP congestion or competition for access to the communication medium that the use of protocols such as TCP engenders.

One of the problems of transporting data in ad-hoc networks, in which real-time data streams have to be protected, is to provide a procedure enabling data or a data stream to be transmitted from a source to a destination without degrading the performance of critical streams such as voice-over IP or VoIP streams or video streams.

The problems associated with ad-hoc networks have been studied by the IETF (Internet Engineering Task Force) research group called the MANET (Mobile Ad-hoc NETworks) group available via the Internet link: www.ietf.org/htlm.charters/manet-charter.htlm. Solutions improving TCP performance in ad-hoc wireless environments have been proposed [ATCP—Ad-hoc Transport Control Protocol], [SNOOP] [TCPF—Transport Control Protocol Feedback]. These solutions, most often operating only at the source, make it possible to improve the performance of data transport in ad-hoc mobile networks, but they do not protect critical streams such as those coming from the VoIP services. Moreover, other approaches modify the TCP protocol using what is called “hop-by-hop” congestion control mechanisms described, for example, in the publication by Y. Yi and S. Shakkottai “Hop-by-Hop Congestion Control over a Wireless Multi-hop Network” IEEE/ACM Transaction on Networking, June 2007. The intermediate nodes correspond to destination notifications from the preceding nodes in the path travelled by the message. These approaches allow more precise and more rapid TCP adaptation but do not deal with protecting the real-time streams. In addition, the retransmission mechanisms remain end-to-end mechanisms. Moreover, the conventional QoS (Quality of Service) IP mechanisms such as scheduling or shaping do not enable the aforementioned problem to be addressed. These mechanisms have too local a vision of the environment since a node has knowledge only about the status of its queues. The nodes have no precise knowledge about the level of competition for transmitting streams over the medium and the nature of the traffic in the medium.

Other solutions proposed by the prior art employ data transport of the “storage and transmission” type. When an entity receives a message, it stores it until it transmits it in turn to a relay node or to the destination. The information is transmitted atomically (transmitted entirely at each hop) and is, usually but not necessarily, self-sufficient. This is for example the case for an email, a video or a text document. The intermediate nodes therefore have a large amount of memory at their disposal. These communication paradigms are similar to those defined in the architecture of the Internet transporting emails [SMTP] or in the communication architecture intended for delay-tolerant networks [DTNRG]. In [OTT06], the authors show the potential of such transport within the context of mobile ad-hoc networks in terms of performance when the transport at each hop takes place using the UDP (user datagram protocol) under CBR (constant bit rate) conditions:

[OTT06] J. Ott, D. Kutscher and C. Dwertmann, “Integrating DTN and MANET routing,” in Proc. CHANTS, 2006;

### [RFC821] RFC 821: J. Postel, “Simple Mail Transfer Protocol (SMTP);

### [SNOOP] Hari Balakrishnan, Srinivasan Seshan and Randy H. Katz, “Improving Reliable Transport and Handoff Performance in Cellular Wireless Networks,” ACM Wireless Networks, 1995;

[TCPF] K. Chandran, S. Raghunathan, S. Venkatesan and R. Prakash, “A feedback based scheme for improving TCP performance in ad-hoc wireless networks,” in Proceedings of the International Conference on Distributed Computing Systems (ICDCS'98), Amsterdam, The Netherlands, May 1998;
[ATCP] J. Liu and S. Singh, “ATCP: TCP for mobile ad-hoc networks,” IEEE JSAC, Vol. 19, No. 7, pp. 1300-1315, July 2001.

For example, the drawback of the transport solution described in [OTT06] is that it involves “hop by hop” atomic handovers between the source and the destination and uses a CBR UDP transport at each hop. It therefore proves to be too aggressive for real-time streams and is not robust since no retransmission mechanism is provided.

### SUMMARY OF THE INVENTION

The subject of the present invention implements a new approach in which the information is transmitted not in the form of packets but in the form of messages containing information that can be self-sufficient, which is handed over from entity to entity atomically.

In an embodiment, the invention relates to a procedure for transporting data in an ad-hoc wireless network, the network comprising several nodes in a configuration at a given instant, namely a source node, a destination node and several intermediate nodes characterized in that it comprises at each of the nodes, at least the following steps:
the message M to be transmitted is split into N packets Pᵢ,
a packet Pᵢ is given to the layers (C₄, C₅) of said node;
   as long as packets Pᵢ remain to be transmitted:
the parameters indicating the quality of the real-time streams in transit on said node are measured, and
the transmission of said packets Pᵢ is authorized or not, by comparing the values of the measured parameters with threshold values;
   if the transmission is authorized, then the packet Pᵢ is transmitted to the MAC layer or to the network layer;
   as long as the packet has not been sent by the network layer to another node forming part of the chosen route, in order to transmit this packet to the destination node:
the parameters indicating the quality of the real-time streams in transit on said node are measured, and
the transmission is authorized or not, by comparing said values of the measured parameters with threshold values;
   if the transmission is not authorized:
a packet Pᵢ is withdrawn from the queue of the MAC layer (if possible), and
the procedure returns to the start of the main loop, i.e. the step in which the procedure attempts to transmit this packet Pᵢ again; the procedure verifies that the transmitted packet has been correctly received using an acknowledgement mechanism, and if the packet has been correctly received the procedure passes to the next packet Pᵢ₊₁.

### BRIEF DESCRIPTION OF THE DRAWINGS

Other features and advantages will become apparent on reading the following detailed description given by way of nonlimiting example in conjunction with the appended drawings which represent:

FIG. 1, the principle of transporting a message within the architecture of FIG. 2; and

FIG. 2, an example of a structure of modules for executing the procedure according to the invention.

### DETAILED DESCRIPTION

To make the subject of the present invention better understood, the procedure will be described in the case of voice-over-IP message transmission considered as a priority data stream compared with other types of data such as data for managing or updating certain databases in the system.

To illustrate the procedure, in the case of an application for a tactical network, it is possible to imagine that the priority stream is that of an emergency call compared with other information.

The procedure may be implemented in the form of software in a protocol stack. It may also be implemented in the form of onboard software.

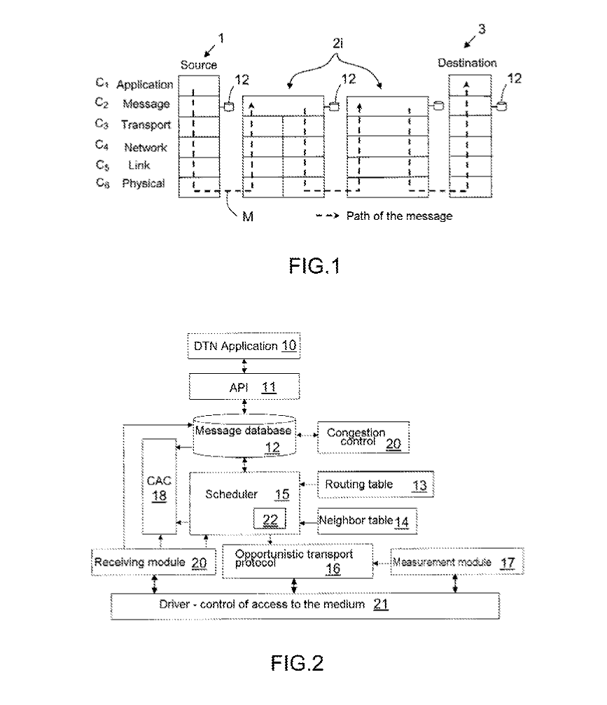

The network in which the procedure according to the invention is implemented, described in FIG. 1, is an ad-hoc network comprising several mobile nodes, which, at a given instant, form part of the network and which can leave the network. The procedure is therefore decentralized, that is to say each node constituting the network at a given instant comprises all the means for the transmission of a message and the reception of information, such as the acknowledgement of a received message, and also the modules detailed in FIG. 2 for executing the steps of the procedure according to the invention. The procedure is executed hop by hop, that is to say the message or messages are transmitted within the network by a “hop by hop” mechanism. The applications requiring data to be transported from a source to a destination transmit messages to the protocol stack provided by way of example. The messages are then transported hop by hop along a defined route by the routing tables and the neighbor tables contained in the nodes as will be explained below.

FIG. 1 depicts the image of a network at a given instant, comprising a source node 1, several intermediate nodes 2, and a destination node 3.

The source node 1 comprises an application layer C₁, a layer C₂, through which the messages to be transmitted pass, a transport layer C₃, a network layer C₄, a link layer C₅ and a physical layer C₆. These layers are known to those skilled in the art and will not be described in detail here.

The destination node 3 comprises the same number of layers as the source node 1.

The intermediate nodes, or relay nodes, forming part of the path travelled by a message do not include an application layer or, at the very least, this layer is not used.

FIG. 2 shows the various modules contained in a network node for handling the messages that are not considered as priority messages. The module 10 generates only non-priority messages. The other data streams considered in the application as priority streams are generated by other applications and will not be described since they are not involved in the steps implemented by the procedure according to the invention.

The DTN application module 10 relates to applications located in the source (source node in this example) and located in the message destination (destination node). A module 10 generates and receives messages M consisting of information that may be self-sufficient, such as electronic messages or images, but not necessarily so. The messages M potentially have any size. These applications do not have real-time constraints.

10. DTN Application: Application generating data streams without real-time constraint.
11. API: The applications transmit and receive the messages via this API (Application Programming Interface).
12. Message database: The nodes of the network using the procedure are provided with a memory enabling them to store the messages in transit, i.e. those which are intended to be retransmitted to their destination node. This database is filled or read by the applications using the above API.
13. Routing table: This table contains the routes indicating which relay mode is chosen for reaching such or such a destination. This table is filled by a routing protocol that may be of the unicast IP type (e.g., OLSR) or of the DTN type (e.g., ProPhet—Probabilistic Routing Protocol using History of Encounters and Transitivity) [LIN04]. These mechanisms are known to those skilled in the art in the field of routing and will not be discussed in detail.
14. Neighborhood table: This table contains the list of nodes with which the current node is in contact (e.g. in wireless range). Likewise, the procedure uses conventional mechanisms for the neighborhood table.
15. Handover scheduling: This module serves to decide which message must now be handed over by the opportunistic handover module 16 described below. This decision is taken using the information provided by the routing and neighborhood tables and the optional mechanisms managing the priorities between the messages. A node should be involved only in one message handover at a time, although this property is not absolute.
16. Opportunistic transmission module: This module is responsible for transporting messages from one node to another. It splits the message to be transmitted into packets (for example, it may split the message into several IP packets). It is this module that takes the decision at each instant to give or not give the next waiting packet to the MAC layer depending on the information returned by the measurement module 8. This module comprises a counter 22 for monitoring the number of packets Pᵢ transmitted.
17. Measurement module: This module returns the values of parameters measured locally or in the neighborhood to the opportunistic transmission module 16. For example, the measured parameters may be the average jitter and the average loss rate of the real-time streams in transit in the wireless coverage zone of the node or any other parameter that a person skilled in the art considers to be useful for deciding on transmitting the data. Thus, the opportunistic transmission module 16 is designed to evaluate whether dispatching packets that it is on the point of generating will cause competition that may degrade the real-time streams. The decision by the opportunistic handover module 16 to dispatch the next packet or not to dispatch it may be taken for example using thresholds on the values of the parameters measured by the present measurement module 17.

In general, the measurements that this module makes may incorporate local information, for example statistics returned by the “driver” 21 relating to the transmissions that have been made in the recent past, information relating to the real-time streams in transit at the current node or coming from the neighborhood (e.g. the real-time streams exchanged in the neighborhood, or statistics relating to air interfaces on the neighboring nodes obtained by a beaconing protocol). The measurement module may be based on the state of congestion of the network arteries or of the arteries linking with the node in question.

18. CAC: This module decides whether the current node is capable of accepting an incoming message handover. This decision is made by taking into account information about the size of the database 12, possible handovers that have been scheduled by 14, or information about the state of the node (e.g. energy).
19. Receiving module: The function of this module is to receive the data messages. It may or may not return acknowledgements to the transmitting node (e.g. ACK, SACK (Selective ACKnowledgement)). Once the message has been received in its entirety, this receiving module stores it in the message database 12.
20. Congestion control: This optional module serves to exchange messages between the nodes participating in the handovers so as to provide congestion control from end to end or in an overall manner in the network.
21. MAC layer: This module represents the layer for access to the medium, this layer being specific to each type of wireless interface. It is capable of providing the measurement module 17 with statistics and is capable of transmitting and receiving packets over the air interface.
22. Counter: This module represents the counter used when transmitting a message by the transport protocol (16).

### [LIN04] A. Lindgren, A. Doria and O. Schelen, “Probabilistic Routing in Intermittently Connected Networks”, LNCS, Vol. 3126. 2004.

The procedure implemented by the present invention comprises, for example, the following steps:

Once the application 10 has generated a message, it is sent to the application 11 that serves as interface of the database 12 in which the messages to be transmitted are stored. The message is then recovered by the scheduler 15 responsible for scheduling its handover. This scheduling is carried out using the information coming from the routing table 13 indicating the available route or routes for transmitting the message or messages and also information coming from the table containing the neighboring nodes 14 indicating whether the next node on the routes is available or not. The scheduler may also receive an acknowledgement or correct-reception message coming from the receiving module 19. Once the acknowledgement message has been received, the message that has been correctly transmitted, and therefore sent to its destination, may be removed from the database.

The messages coming from the scheduler 15 are then transmitted to the opportunistic handover module 16 responsible for handing over the message to the next hop. To do this it uses the measurements made by the measurement module 17 that takes into account the parameters measured in the wireless vicinity relating to the real-time streams that it is desired to protect.

The distributed algorithm of the decision to send messages within the context of the opportunistic transport protocol 16 comprises the steps described below and is implemented at each node constituting a network at a given instant.

The route used for transmitting a message is determined from the information contained in the routing table and in the table giving the closest neighbors using mechanisms or techniques known to those skilled in the art.

The message generated by the application 10 is placed in a main queue at a node.

A first step consists in dividing the message M into N packets P. The number N is known at the start. It is possible to use a counter set to zero or N depending on whether it is chosen to increment this counter or decrement it each time a packet Pᵢ is transmitted.

A packet Pᵢ is given to the network layer or to the MAC (Medium Access Control) layer.

As long as packets Pᵢ remain to be transmitted:
verify if the parameters returned by the measurement module 17 to the opportunistic protocol module 16 indicate that a handover may take place without degrading the neighboring real-time streams,
   if yes, then the packet Pᵢ is transmitted to the MAC layer or to the network layer,
      as long as the packet Pᵢ has not been sent by the MAC layer or the network layer to another node 2ⱼ forming part of the chosen route, in order to transmit this packet to the destination node,
      if the moment is no longer opportune for a data transmission (decision taken by the measurement module and transmitted to the opportunistic transport module that notes parameters that have changed unfavorably for transmission), then:
         the packet P, is removed from the queue of the MAC layer,
         an adaptive queuing time mechanism is activated, for example a back-off mechanism (e.g. an AIMD—Additive Increase Multiplicative Decrease) mechanism, this step being optional,
         the procedure returns to the start of the main loop, i.e. the procedure attempts to transmit this packet P, again and verifies if the moment is opportune for transmitting the packet Pᵢ,
      verify that the packet has been correctly received. This may take place using the information provided by the MAC layer or by implementing an acknowledgement mechanism in the receiving module of a node. Other acknowledgement mechanisms may be used such as the SACK (Selective ACKnowledgement) mechanism. If the packet has been correctly received, then a counter 22 associated with Pᵢ is incremented by 1 and the procedure passes to the packet and
   the procedure waits for a random, constant time, or it calculates on another mechanism, such as for example AIMD, this step being optional.
For each packet P, to be transmitted, the opportunistic handover protocol 16 waits for the measurement module 17 to indicate to it that a good opportunity exists. As soon as the conditions are favorable, the opportunistic protocol hands over the packet to the MAC layer. In the case in which a packet could not be sent by the MAC layer, the procedure is reiterated, and it is attempted to retransmit the same packet P, before the next packet in the queue Pᵢ₊₁ is transmitted. Moreover, when the packet is queued in the MAC layer and the transmission conditions become unfavorable, a back-off mechanism may then be used to repeat the transmission attempt, for example after linearly increasing time periods. To do this, it is possible to use the AIMD algorithm that has a feature of preserving the context in memory: if there is a failure in transmitting the packet, the procedure waits; if successful, there is a reduction in the queuing time. It is also possible to employ any other solution known to those skilled in the art. Finally, after each success or failure, a constant queuing time may be put into place.

The opportunistic handover module manages and orders the transmission times and the queuing times. The queuing time may be random if there is no coordination between the nodes. In other cases, the queuing time is zero and the attempt to retransmit a packet is virtually immediate.

The invention therefore makes it possible to transport information stored in the form of a message from a source to a destination, while protecting the real-time traffic such as voice-over-IP traffic.

1. A method for transporting data in an ad-hoc wireless network, the network comprising several nodes in a configuration at a given instant, namely a source node, a destination node and several intermediate nodes, the method comprising executing at each of the nodes, at least the following steps:
the message M to be transmitted is split into N packets Pᵢ,
a packet Pᵢ is given to the layers of said node;
as long as packets Pᵢ remain to be transmitted:
the parameters indicating the quality of the real-time streams in transit on said node are measured, and
the transmission of said packets Pᵢ is authorized or not, by comparing the values of the measured parameters with threshold values;
if the transmission is authorized, then one of said packets Pᵢ is transmitted to the MAC layer or to the network layer;
as long as the packet Pᵢ has not been sent by the network layer to another node forming part of the chosen route, in order to transmit this packet to the destination node:
the parameters indicating the quality of the real-time streams in transit on said node are measured, and
the transmission is authorized or not, by comparing said values of the measured parameters with threshold values;
if the transmission is not authorized:
a packet Pᵢ is withdrawn from the queue of the MAC layer (if possible), and
the procedure returns to the start of the main loop, i.e. the step in which the procedure attempts to transmit this packet Pᵢ again;
the procedure verifies that said transmitted packet Pᵢ has been correctly received using an acknowledgement mechanism, and if the packet has been correctly received the procedure passes to the next packet Pᵢ₊₁.

2. The method as claimed in claim 1, wherein, between two attempts to transmit a packet Pᵢ, the procedure applies a constant or variable queue delay.

3. The method as claimed in claim 1, wherein after the packet has been removed from the queue, the procedure activates a queuing time mechanism.

4. The method as claimed in claim 3, wherein the queuing time mechanism is a back-off mechanism of the AIMD type.

5. A device for transporting data streams in a network comprising several nodes in a given configuration at a given instant, wherein it the device comprises in combination at least the following elements:
a database storing the message or messages to be transmitted;
a congestion control module connected to said database;
a scheduler having as inputs the messages stored in the database, the route determined for a message by a routing table and a neighboring node table and information coming from a receiving module;
a module comprising an opportunistic transport protocol receiving information from the scheduler and from a measurement module, said opportunistic transport protocol being designed to split a message to be transmitted into N packets Pᵢ, and transmitting said packets to the network layer of said node, said module comprising a counter; and
a module designed to decide if the current node is capable of accepting an incoming handover of a message.

6. The device as claimed in claim 5, wherein the measurement module is designed to measure values of parameters at least measured locally or in the vicinity of a node.

7. The device as claimed in claim 6, wherein the measured parameters are the average jitter and the average loss rate of the real-time streams in transit in the coverage zone of said node.

8. The device as claimed in claim 5, wherein the network is an ad-hoc network.
